(19) United States
(12) Patent Application Publication
(10) Pub. No.: US 2013/0322644 A1
(43) Pub. Date: Dec. 5, 2013

(54) Sound Processing Apparatus

(71) Applicant: Yamaha Corporation, Hamamatsu-shi (JP)

(72) Inventor: Yu TAKAHASHI, Hamamatsu-shi (JP)

(73) Assignee: Yamaha Corporation, Hamamatsu-shi (JP)

(21) Appl. No.: 13/904,185

(22) Filed: May 29, 2013

(30) Foreign Application Priority Data
May 31, 2012 (JP) 2012-124253

(51) Int. Cl. G10K 11/175

(52) U.S. Cl. CPC G10K 11/175
USPC 381/73.1

(57) ABSTRACT

A sound processing apparatus has one or more of processors configured to suppress peaks that exist in a high-order region of a cepstrum of a sound signal and that correspond to a harmonic structure of the sound signal. The processor is further configured to generate a separation mask used to suppress a harmonic component or a nonharmonic component of the sound signal based on a resultant cepstrum in which the peaks of the high-order region have been suppressed.

### BACKGROUND OF THE INVENTION

1. Technical Field of the Invention

The present invention relates to technology for processing a sound signal.

2. Description of the Related Art

Technology for separating a sound signal composed of a mixture of a harmonic component, such as sound of a string instrument, human voice or the like, and a nonharmonic component, such as sound of percussion, into a harmonic component and a nonharmonic component has been proposed. For example, non-patent references 1 and 2 disclose technologies for separating a sound signal into a harmonic component and a nonharmonic component on the assumption that the harmonic component is sustained in the direction of the time domain whereas the nonharmonic component is sustained in the direction of the frequency domain (anisotropy).
[Non-Patent Reference 1] N. Ono, et al., “Separation of a monaural audio signal into harmonic/percussive components by complementary diffusion on spectrogram”, Proc. EUSIPCO2008, 2008
[Non-Patent Reference 2] N. Ono, et al., “A real-time equalizer of harmonic and percussive components in music signals”, Proc. ISMIR2008, pp. 139-144, 2008

In the technologies of non-patent references 1 and 2, however, since temporal continuity of a sound signal needs to be evaluated, intervals corresponding to durations before and after a specific point of the sound signal are necessary to analyze harmonic/percussive components relating to the specific point of the sound signal. Accordingly, storage capacity (a buffer) necessary to temporarily store the sound signal increases and it is difficult to perform processing in real time.

### SUMMARY OF THE INVENTION

In view of this, an object of the present invention is to estimate a harmonic component or a nonharmonic component of a sound signal without requiring the sound signal to be sustained for a long time.

Means employed by the present invention to solve the above-described problem will be described. To facilitate understanding of the present invention, correspondence between components of the present invention and components of embodiments which will be described later is indicated by parentheses in the following description. However, the present invention is not limited to the embodiments.

A sound processing apparatus of the present invention comprises one or more of processors configured to: compute a cepstrum of a sound signal; suppress peaks that exist in a high-order region of the cepstrum of the sound signal and that correspond to a harmonic structure of the sound signal; generate a separation mask (e.g. harmonic estimation mask MH[t], nonharmonic estimation mask MP[t]) used to suppress a harmonic component or a nonharmonic component of the sound signal based on a resultant cepstrum in which the peaks of the high-order region have been suppressed; and apply the separation mask to the sound signal.

In this configuration, since the separation mask is generated based on the result of suppression of the peaks of the high-order region corresponding to the harmonic structure of the harmonic component in the cepstrum of the sound signal, the harmonic component or nonharmonic component of the sound signal can be estimated without requiring the sound signal to be sustained for a long time.

In a first embodiment of the sound processing apparatus according to the present invention, the processor is configured to: generate, as the separation mask, a harmonic estimation mask capable of suppressing the nonharmonic component of the sound signal and a nonharmonic estimation mask capable of suppressing the harmonic component of the sound signal; and apply the harmonic estimation mask to the sound signal (e.g. first processor 72A) and apply the nonharmonic estimation mask to the sound signal (e.g. second processor 74A).

In a second embodiment of the sound processing apparatus according to the present invention, the processor is configured to: generate, as the separation mask, a harmonic estimation mask capable of suppressing the nonharmonic component of the sound signal; apply the harmonic estimation mask to the sound signal to estimate the harmonic component of the sound signal (e.g. first processor 72B); and estimate the nonharmonic component of the sound signal by suppressing the estimated harmonic component from the sound signal (e.g. second processor 74B).

According to a preferred embodiment of the present invention, the processor is configured to: transform a low-order component of the cepstrum computed from the sound signal and a high-order component of the resultant cepstrum, in which the peaks have been suppressed, into a first spectrum (e.g. frequency component E[f, t]) of a frequency domain; and generate the separation mask based on the first spectrum and a second spectrum (e.g. frequency component X[f, t]) of the sound signal.

In the present embodiment, since the separation mask is generated based on the spectrum, obtained by transforming the low-order component of the cepstrum computed from the sound signal and the high-order component of the resultant cepstrum, and the spectrum of the sound signal, an envelope structure of the sound signal can be sufficiently sustained before and after the sound signal is processed.

According to a preferred embodiment of the present invention, the processor is configured to suppress the peaks existing in the high-order region of the cepstrum corresponding to the harmonic structure of the sound signal by approximating the high-order region of the cepstrum to 0 or by substituting the high-order region of the cepstrum by 0.

A process of approximating the cepstrum of the high-order region to 0 corresponds to a process of suppressing a fine structure corresponding to the harmonic component in the amplitude spectrum of the sound signal (i.e., process of smoothing the amplitude spectrum in the direction of the frequency domain). Since the nonharmonic component tends to be sustained in the direction of the frequency domain, a degree of separation of the harmonic component or the nonharmonic component can be improved according to the configuration for approximating the cepstrum of the high-order region to 0.

Furthermore, according to a configuration in which 0 is substituted for the cepstrum of the high-order region, the process of the harmonic suppression can be simplified and an operation with respect to the high-order region during transformation into the frequency domain can be omitted (and thus computational load can be reduced).

In addition, in a preferred embodiment, the processor is configured to adjust the cepstrum in a first range (e.g. range Q_{B1}) corresponding to a low-order side of the high-order region (e.g., Q_{B}) of the cepstrum according to a weight continuously varying with increase of quefrency so as to suppress the peaks, and to approximate the cepstrum in a second range (e.g. range Q_{B2}) corresponding to a high-order side with respect to the first range in the high-order region to 0 (substituting 0 or a numerical value close to 0 for the cepstrum, for example).

According to a preferred embodiment of the present invention, the processor is configured to suppress only a part of the peaks that belongs to a predetermined range of the high-order region of the cepstrum and that corresponds to a pitch of the sound signal.

In this embodiment, computational load of the harmonic suppression is reduced, compared to a configuration in which peaks in the entire high-order region are suppressed, since peaks in a specific range corresponding to the pitches of the sound signal in the high-order region are suppressed.

The present invention may be implemented as a sound processing apparatus (separation mask generation apparatus) for generating a separation mask. That is, a sound processing apparatus according to another embodiment of the present invention comprises one or more of processors configured to: suppress peaks that exist in a high-order region of a cepstrum of a sound signal and that correspond to a harmonic structure of the sound signal; and generate a separation mask used to suppress a harmonic component or a nonharmonic component of the sound signal based on a resultant cepstrum in which the peaks of the high-order region have been suppressed.

According to this configuration, the separation mask can be generated without requiring that the sound signal be sustained for a long time.

The sound processing apparatus according to each embodiment of the present invention may not only be implemented by hardware (electronic circuitry) dedicated for music analysis, such as a digital signal processor (DSP), but may also be implemented through cooperation of a general operation processing device such as a central processing unit (CPU) with a program. A program according to the first aspect of the invention executes on a computer: a feature extraction process of computing a cepstrum of a sound signal; a harmonic suppression process of suppressing peaks that exist in a high-order region of the cepstrum of the sound signal and that correspond to a harmonic structure of the sound signal; a separation mask generation process of generating a separation mask used to suppress a harmonic component or a nonharmonic component of the sound signal based on a resultant cepstrum in which the peaks of the high-order region have been suppressed; and a signal process of applying the separation mask to the sound signal.

According to this program, the same operation and effect as those of the sound processing apparatus according to the present invention can be achieved. The program according to the present invention can be stored in a computer readable recording medium and installed in a computer, or distributed through a communication network and installed in a computer.

### BRIEF DESCRIPTION OF THE DRAWINGS

FIG. 1 is a block diagram of a sound processing apparatus according to a first embodiment of the present invention.

FIG. 2 illustrates a low-order region and a high-order region of a cepstrum.

FIG. 3 is a block diagram of a harmonic suppressor, a separation mask generator and a signal processor in the sound processing apparatus according to the first embodiment of the invention.

FIG. 4 is a block diagram of a harmonic suppressor, a separation mask generator and a signal processor in a sound processing apparatus according to a second embodiment of the invention.

FIG. 5 is a block diagram of a harmonic suppressor, a separation mask generator and a signal processor in a sound processing apparatus according to a third embodiment of the invention.

FIG. 6 illustrates peak suppression performed in a modification.

FIG. 7 is a flowchart showing a sound processing method performed by the sound processing apparatus.

### DETAILED DESCRIPTION OF THE INVENTION

### First Embodiment

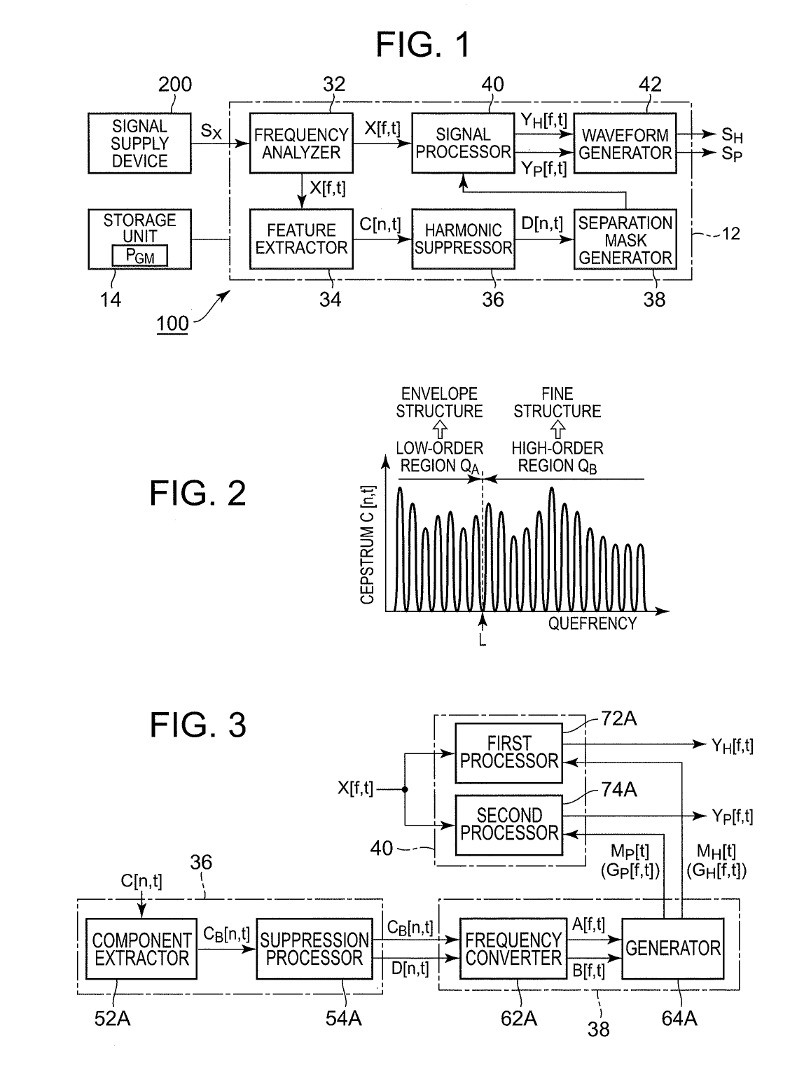

FIG. 1 is a block diagram of a sound processing apparatus 100 according to a first embodiment of the present invention. A signal supply device 200 is connected to the sound processing apparatus 100. The signal supply device 200 supplies a sound signal S_{X} to the sound processing apparatus 100. The sound signal S_{X} is a time domain signal having a waveform representing a mixture of a harmonic component and a nonharmonic component. The harmonic component refers to a harmonic sound component such as sound of a musical instrument, e.g. string instrument or wind instrument, human voice, etc., and the nonharmonic component refers to a non-harmonic sound component such as sound of percussion, various noises (e.g. sound of an HVAC (heating, ventilation, air conditioning) system, environmental sound such as crowd noise, etc.). It is possible to employ, as the signal supply device 200, a sound collection device that generates the sound signal S_{X} by collecting surrounding sound, a reproduction device that obtains the sound signal S_{X} from a variable or built-in recording medium and provides the sound signal S_{X} to the sound processing apparatus 100, and a communication device that receives the sound signal S_{X} from a communication network and provides the sound signal S_{X} to the sound processing apparatus 100, for example.

The sound processing apparatus 100 generates sound signals S_{H} and S_{P} from the original sound signal S_{X} supplied from the signal supply device 200. The sound signal S_{H} (H: harmonic) is a time domain signal generated by estimating a harmonic component (by suppressing a nonharmonic component) of the sound signal S_{X}, and the sound signal S_{P} (P: percussive) is a time domain signal generated by estimating the nonharmonic component (suppressing the harmonic component) of the sound signal S_{X}. The sound signals S_{H} and S_{P} generated by the sound processing apparatus 100 are selectively provided to a sound output device (not shown) and output as sound waves.

As shown in FIG. 1, the sound processing apparatus 100 is implemented as a computer system including a processing unit 12 and a storage unit 14. The storage unit 14 stores a program PGM executed by the processing unit 12 and data used by the processing unit 12. A known recording medium such as a semiconductor recording medium and a magnetic recording medium or a combination of various types of recording media may be employed as the storage unit 14. A configuration in which the sound signal S_{X} is stored in the storage unit 14 is preferable (in this case, the signal supply device 200 is omitted).

The processing unit 12 implements a plurality of functions (functions of a frequency analyzer 32, a feature extractor 34, a harmonic suppressor 36, a separation mask generator 38, a signal processor 40, and waveform generator 42) for generating the sound signals S_{H} and S_{P} from the sound signal S_{X} by executing the program PGM stored in the storage unit 14. It is possible to employ a configuration in which the functions of the processing unit 12 are distributed to a plurality of units and a configuration in which some functions of the processing unit 12 are implemented by a dedicated circuit (DSP).

The frequency analyzer 32 sequentially calculates a frequency component (frequency spectrum) X[f, t] of the sound signal S_{X} for respective unit periods in the time domain. Here, f refers to a frequency (frequency bin) in the frequency domain, and t refers to an arbitrary time (unit period) in the time domain. A known frequency analysis method such as short-time Fourier transform is employed to calculate each frequency component X[f, t].

The feature extractor 34 sequentially calculates a cepstrum C[n, t] of the sound signal Sx for respective unit periods. The cepstrum C[n, t] is computed through discrete Fourier transform of a logarithm of the frequency component X[f, t] (amplitude |X[f, t]|) calculated by the frequency analyzer 32, as represented by Equation (1).

$$C [ n , t ] = {\sum }_{f} log \vert X [ f , t ] \vert exp ( 2 π fn / N ) \qquad ( 1 )$$

In Equation (1), n denotes a quefrency and N denotes the number of points of discrete Fourier transform. While Equation (1) represents computation of a real-number cepstrum, a complex cepstrum can be computed.

As shown in FIG. 2, a low-order region (region having a low quefrency) Q_{A} of the cepstrum C[n, t] of the sound signal S_{X} corresponds to a coarse structure (referred to as “envelope structure” hereinafter) of the amplitude spectrum of the sound signal S_{X}, and a high-order region (region having a high quefrency) Q_{B} corresponds to a fine periodic structure (referred to as “fine structure” hereinafter). A harmonic structure (harmonic structure in which the first or basic harmonic and a plurality of harmonic components are arranged at equal intervals in the frequency domain) of a harmonic component included in the sound signal S_{X} is a fine periodic structure. Accordingly, the harmonic structure of the harmonic component tends to be predominant in the high-order region of the cepstrum C[n, t].

FIG. 3 is a block diagram of the frequency suppressor 36, the separation mask generator 38 and the signal processor 40 according to the first embodiment. The frequency suppressor 36 suppresses peaks of the high-order region Q_{B} corresponding to the fine structure in the cepstrum C[n, t] computed by the feature extractor 34, and includes a component extractor 52A and a suppression processor 54A, as shown in FIG. 3. The component extractor 52A extracts (lifters) a component C_{B}[n, t] of the high-order region QB (referred to as “high-order component” hereinafter) from the cepstrum C[n, t] of the sound signal S_{X}. Specifically, the component extractor 52A computes the high-order component C_{B}[n, t] by substituting 0 for the cepstrum C[n, t] of the low-order region Q_{A} in which the quefrency n is less than a predetermined threshold value L (refer to FIG. 2), as represented by Equation (2).

$${C}_{B} [ n , t ] = \{ \begin{matrix}0 & ( n < L ) \\ C [ n , t ] & ( n \geq L )\end{matrix} \qquad ( 2 )$$

The threshold value L corresponding to the boundary of the low-order region Q_{A} and the high-order region Q_{B} is selected experimentally or statistically such that a cepstrum C[n, t] of a primary harmonic component assumed to be the sound signal S_{X} can belong to the high-order region Q_{B}.

The suppression processor 54A shown in FIG. 3 generates a harmonic suppressed component (cepstrum) D[n, t] by suppressing peaks of the high-order component C_{B}[n, t] generated by the component extractor 52A. As described below, the fine structure of the sound signal S_{X} is predominant in the high-order region Q_{B} of the cepstrum C[n, t]. The fine structure is derived from the harmonic structure of the harmonic component included in the sound signal S_{X}. That is, peaks of the high-order component C_{B}[n, t] tends to correspond to the harmonic structure of the harmonic component of the sound signal S_{X}. Accordingly, the harmonic suppressed component D[n, t] obtained by suppressing peaks of the high-order component C_{B}[n, t] corresponds to a component in which the harmonic component of the sound signal S_{X} has been suppressed.

The suppression processor 54A according to the first embodiment generates the harmonic suppressed component D[n, t] using a median filter represented by Equation (3).

D[n,t]=median{C_{B}[n−v,t], . . . ,C_{B}[n,t], . . . ,C_{B}[n+v,t]} (3)

In Equation (3), a function median{ } represents a median of high-order components {C_{B}[n−v,t] to C_{B}[n+v,t]} corresponding to (2v+1) quefrencies having one quefrency n at the center. Accordingly, the harmonic suppressed component D[n, t] obtained by suppressing peaks of the high-order component C_{B}[n, t] is generated as resultant cepstrum.

The separation mask generator 38 shown in FIG. 3 sequentially generates a separation mask used to separate the sound signal S_{X} into the harmonic component and the nonharmonic component according to the result (harmonic suppressed component D[n, t]) of processing by the harmonic suppressor 36 for respective unit periods. The separation mask generator 38 according to the first embodiment generates a separation mask (referred to as “harmonic estimation mask” hereinafter) M_{H}[t]used to extract the harmonic component of the sound signal S_{X} by suppressing the nonharmonic component of the sound signal S_{X} and a separation mask (referred to as “nonharmonic estimation mask” hereinafter) M_{P}[t] used to extract the nonharmonic component of the sound signal S_{X} by suppressing the harmonic component of the sound signal S_{X} for each unit period. As shown in FIG. 3, the separation mask generator 38 according to the first embodiment includes a frequency converter 62A and a generator 64A.

The frequency converter 62A converts the high-order component C_{B}[n, t] generated by the component extractor 52A and the harmonic suppressed component D[n, t] generated by the suppression processor 54A into frequency spectra. A process for transforming a cepstrum into a spectrum is composed of index transformation and discrete Fourier transform. Specifically, the frequency converter 62A computes a frequency component A[f, t] by performing an operation according to Equation (4) on the high-order component C_{B}[n, t] and calculates a frequency component B[f, t] by performing an operation according to Equation (5) on the harmonic suppressed component D[n, t].

$$\begin{matrix}A [ f , t ] = {\sum }_{n} exp ( {C}_{B} [ n , t ] ) exp ( - 2 π fn / N ) & ( 4 ) \\ B [ f , t ] = {\sum }_{n} exp ( D [ n , t ] ) exp ( - 2 π fn / N ) & ( 5 )\end{matrix}$$

As is understood from the above description, the frequency component A[f, t] corresponds to an amplitude spectrum obtained by suppressing the envelope structure (cepstrum C[n, t] of the low-order region Q_{A}) in the amplitude spectrum of the sound signal S_{X} (that is, amplitude spectrum from which the fine structures of the harmonic component and the nonharmonic component have been extracted). The frequency component B[f, t] corresponds to an amplitude spectrum (that is, amplitude spectrum from which the fine structure of the nonharmonic component has been extracted) obtained by suppressing the harmonic structure of the harmonic component, from among the fine structures extracted from the amplitude spectrum of the sound signal S_{X}.

The generator 64A shown in FIG. 3 generates the harmonic estimation mask M_{H}[t] and the nonharmonic estimation mask M_{P}[t] using the frequency components A[f, t] and B[f, t] generated by the frequency converter 62A. The harmonic estimation mask M_{H}[t] is a numeric string of a plurality of processing coefficients G_{H}[f, t] corresponding to different frequencies and the nonharmonic estimation mask M_{P}[t] is a numeric string of a plurality of processing coefficients G_{P}[f, t]corresponding to different frequencies. The processing coefficients G_{H}[f, t] and the processing coefficients G_{P}[f, t] correspond to gains (spectral gains) with respect to the frequency component X[f, t] of the sound signal S_{X} and are variably set in the range of 0 to 1.

Specifically, the generator 64A according to the first embodiment computes the processing coefficients G_{P}[f, t] of the nonharmonic estimation mask M_{P}[t] according to Equation (6) and computes the processing coefficients G_{H}[f, t] of the harmonic estimation mask M_{H}[t] through according to Equation (7).

$$\begin{matrix}{G}_{P} [ f , t ] = \frac{B [ f , t ]}{A [ f , t ]} & ( 6 ) \\ {G}_{H} [ f , t ] = 1 - {G}_{P} [ f , t ] & ( 7 )\end{matrix}$$

As described above, since the frequency component A[f, t] corresponds to the amplitude spectrum from which the fine structures of the harmonic component and the nonharmonic component have been extracted and the frequency component B[f, t] corresponds to the amplitude spectrum obtained by suppressing the harmonic structure of the harmonic component, from among the fine structures, the frequency component B[f, t] has a value smaller than the frequency component A[f, t] at a frequency f at which the harmonic component is predominant and approximates the frequency component A[f, t] at a frequency f at which the nonharmonic component is predominant. Accordingly, as is understood from Equation (6), the processing coefficients G_{P}[f, t] decrease to a small value less than 1 at the frequency f (i.e., frequency f which is more likely to correspond to the harmonic component) at which the harmonic component is predominant and approximates 1 at the frequency f at which the nonharmonic component is predominant. Furthermore, as is understood from Equation (7), the processing coefficients G_{H}[f, t] decrease to a small value less than 1 at the frequency f (i.e., frequency f corresponding to large processing coefficients G_{P}[f, t]) at which the nonharmonic component is predominant and approximates to 1 at the frequency f at which the harmonic component is predominant.

The signal processor 40 shown in FIG. 1 generates each frequency component Y_{H}[f, t] of the sound signal S_{H} and each frequency component Y_{P}[f, t] of the sound signal Sₚ by applying the separation masks (harmonic estimation mask M_{H}[t] and nonharmonic estimation mask Mₚ[t]) generated by the separation mask generator 38 to the sound signal S_{X}. As shown in FIG. 3, the signal processor 40 according to the first embodiment of the present invention includes a first processor 72A generating the frequency component Y_{H}[f, t] and a second processor 74A generating the frequency component Y_{P}[f, t].

The first processor 72A calculates the frequency component Y_{H}[f, t] of the sound signal S_{H} by applying the harmonic estimation mask M_{H}[t] to the frequency component X[f, t] of the sound signal S_{X}. Specifically, the first processor 72A computes the frequency component Y_{H}[f, t] by multiplying the frequency component X[f, t] by each processing coefficient G_{H}[f, t] of the harmonic estimation mask M_{H}[t], as represented by Equation (8).

Y_{H}[f,t]=G_{H}[f,t]X[f,t] (8)

Since the processing coefficient G_{H}[f, t] is set to a large value at the frequency f at which the harmonic component is predominant, the frequency component Y_{H}[f, t] computed according to Equation (8) corresponds to a spectrum obtained by suppressing the nonharmonic component of the sound signal S_{X} and extracting the harmonic component of the sound signal S_{X}.

The second processor 74A calculates the frequency component Y_{P}[f, t] of the sound signal S_{P} by applying the nonharmonic estimation mask M_{P}[t] to the frequency component X[f, t] of the sound signal S_{X}. Specifically, the second processor 74A computes the frequency component Y_{P}[f, t] by multiplying the frequency component X[f, t] by each processing coefficient G_{P}[f, t] of the nonharmonic estimation mask M_{P}[t], as represented by Equation (9).

Y_{P}[f,t]=G_{P}[f,t]X[f,t] (9)

Since the processing coefficient G_{P}[f, t] is set to a large value at the frequency f at which the nonharmonic component is predominant, the frequency component Y_{P}[f, t] computed according to Equation (9) corresponds to a spectrum obtained by suppressing the harmonic component of the sound signal S_{X} and extracting the nonharmonic component of the sound signal S_{X}.

The waveform generator 42 shown in FIG. 1 generates the sound signals S_{H} and S_{P} respectively corresponding to the frequency components Y_{H}[f, t] and Y_{P}[f, t] generated by the signal processor 40. Specifically, the waveform generator 42 generates the sound signal S_{H} by transforming the frequency component Y_{H}[f, t] corresponding to each unit period into a time domain signal through short-time inverse Fourier transform and connecting time domain signals corresponding to consecutive unit periods. The sound signal S_{P} is generated from the frequency components Y_{P}[f, t] in the same manner.

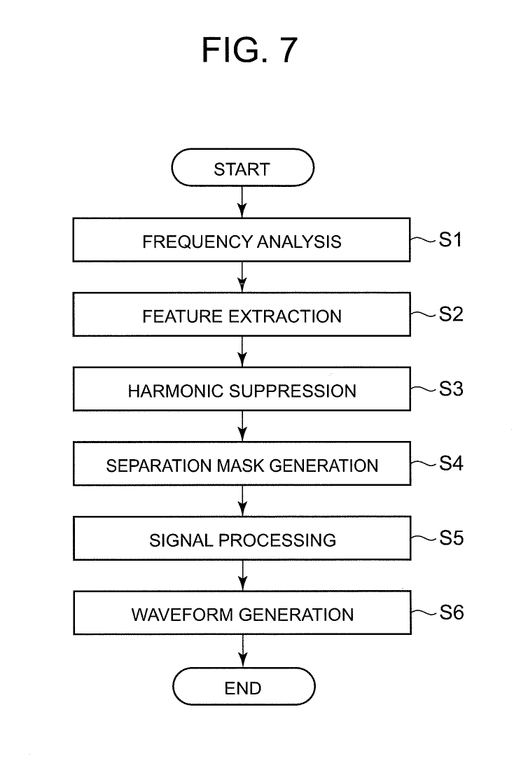

FIG. 7 is a flowchart showing a sound processing method performed by the sound processing apparatus 100. First, in frequency analysis process of Step S1, a frequency component X[f, t] of the sound signal S_{X} is sequentially calculated for respective unit periods. A frequency analysis method such as short-time Fourier transform is employed to calculate each frequency component X[f, t].

Next, in feature extraction process of Step S2, a cepstrum C[n, t] of the sound signal Sx is sequentially calculated for respective unit periods. Specifically, the cepstrum C[n, t] is computed through discrete Fourier transform of a logarithm of the frequency component X[f, t] calculated by Step S1.

Then, in harmonic suppression process of Step S3, peaks of a high-order region Q_{B} corresponding to the fine structure in the cepstrum C[n, t] computed by Step S2 is suppressed. Specifically, a component C_{B}[n, t] of the high-order region QB is extracted from the cepstrum C[n, t] of the sound signal S_{X}. Then, a harmonic suppressed component D[n, t] is generated by suppressing peaks of the high-order component C_{B}[n, t]. The fine structure of the sound signal S_{X} is predominant in the high-order region Q_{B} of the cepstrum C[n, t]. The fine structure is derived from the harmonic structure of the harmonic component included in the sound signal S_{X}. That is, peaks of the high-order component C_{B}[n, t] tend to correspond to the harmonic structure of the harmonic component of the sound signal S_{X}. Accordingly, the harmonic suppressed component D[n, t] obtained by suppressing peaks of the high-order component C_{B}[n, t] corresponds to a component in which the harmonic component of the sound signal S_{X} has been suppressed.

Further, in Step S4, a separation mask used to separate the sound signal S_{X} into the harmonic component and the nonharmonic component is sequentially generated according to the harmonic suppressed component D[n, t] obtained by Step S3. For example, a separation mask is generated in the form of a harmonic estimation mask M_{H}[t] used to extract the harmonic component of the sound signal S_{X} and to suppress the nonharmonic component of the sound signal S_{X}. Another separation mask is generated in the form of a nonharmonic estimation mask M_{P}[t] used to extract the nonharmonic component of the sound signal S_{X} and to suppress the harmonic component of the sound signal S_{X} for each unit period.

In signal processing of Step S5, each frequency component Y_{H}[f, t] of the sound signal S_{H} and each frequency component Y_{P}[f, t] of the sound signal S_{P} is generated by applying the separation masks (harmonic estimation mask M_{H}[t] and nonharmonic estimation mask M_{P}[t]) generated by Step S4. The frequency component Y_{H}[f, t] corresponds to a spectrum obtained by suppressing the nonharmonic component of the sound signal S_{X} and extracting the harmonic component of the sound signal S_{X}. The frequency component Y_{P}[f, t] corresponds to a spectrum obtained by suppressing the harmonic component of the sound signal S_{X} and extracting the nonharmonic component of the sound signal S_{X}.

Lastly in Step S6, sound signals S_{H} and S_{P} respectively corresponding to the frequency components Y_{H}[f, t] and Y_{P}[f, t] are generated. Specifically, the sound signal S_{H} is generated by transforming the frequency component Y_{H}[f, t] corresponding to each unit period into a time domain signal through short-time inverse Fourier transform and connecting time domain signals corresponding to consecutive unit periods. The sound signal S_{P} is generated from the frequency components Y_{P}[f, t] in the same manner.

In the first embodiment of the invention, since the separation masks (harmonic estimation mask M_{H}[t] and nonharmonic estimation mask M_{P}[t]) are generated based on the resultant cepstrum (harmonic suppressed component D[n, t]) obtained by suppressing peaks of the high-order region Q_{B} corresponding to the harmonic structure of the harmonic component in the cepstrum C[n, t] of the sound signal S_{X}, as described above, the harmonic component or the nonharmonic component of the sound signal S_{X} can be estimated without requiring the sound signal S_{X} to be sustained for a long time.

In the technologies of non-patent references 1 and 2, a sound component sustained in the time domain is estimated to be a harmonic component, a sound component sustained in the frequency domain is estimated to be a nonharmonic component, and the two sound components are separated from each other. Accordingly, it is impossible to appropriately process a component (e.g. sound of a high hat durm) sustained in both the time domain and the frequency domain. According to the first embodiment of the present invention, the separation masks are generated by suppressing peaks of the high-order region Q_{B} corresponding to the harmonic structure of the harmonic component in the cepstrum C[n, t] of the sound signal S_{X}. Therefore, even a sound signal sustained in both the time domain and the frequency domain can be separated into a harmonic component and a nonharmonic component with high accuracy.

Furthermore, in the first embodiment of the present invention, since the separation masks are generated from the harmonic suppressed component D[n, t] obtained by suppressing peaks of the cepstrum C[n, t] in the high-order region Q_{B} corresponding to the fine structure, the envelope structure of the sound signal S_{X} is sustained before and after the separation process. Accordingly, it is possible to generate the sound signals S_{H} and S_{P} while sustaining the quality (envelope structure) of the sound signal S_{X}.

### Second Embodiment

A second embodiment of the present invention will now be described. In the following embodiments, components having the same operations and functions as those of corresponding components in the first embodiment are denoted by the same reference numerals and detailed description thereof is omitted.

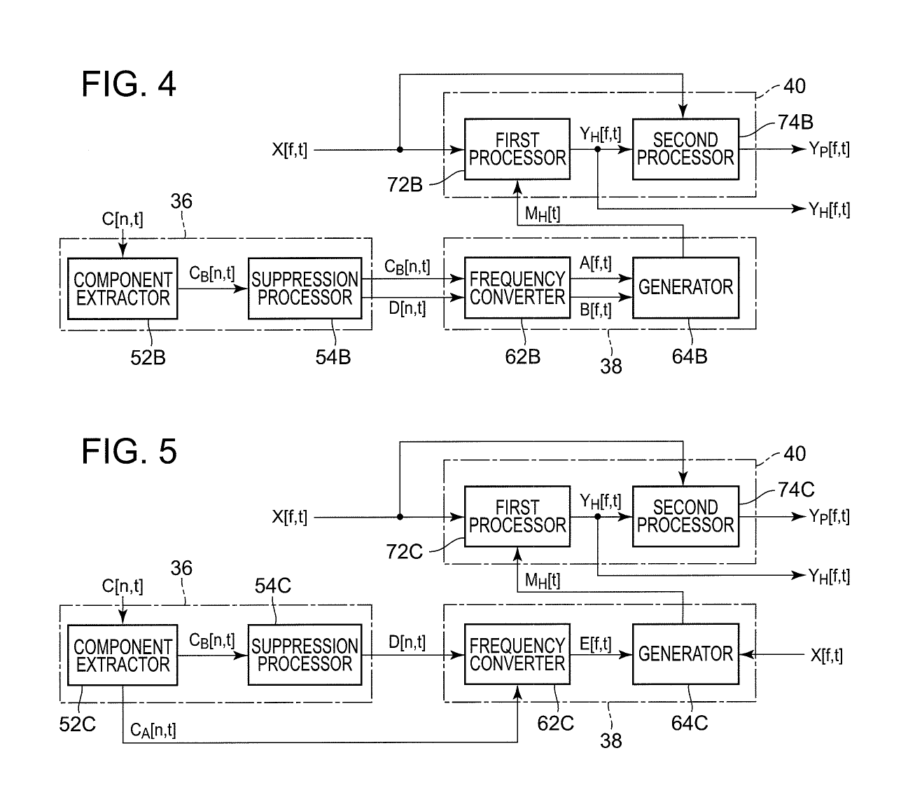

FIG. 4 is a block diagram of the harmonic suppressor 36, the separation mask generator 38 and the signal processor 40 according to the second embodiment of the present invention. The configuration and operation of the harmonic suppressor 36 (component extractor 52B and suppression processor 54B) correspond to those of the harmonic suppressor 36 according to the first embodiment.

The separation mask generator 38 according to the second embodiment includes a frequency converter 62B and a generator 64B. The frequency converter 62B generates the frequency component A[f, t] of the high-order component C_{B}[n, t], obtained by estimating the fine structures of the harmonic component and nonharmonic component, and the frequency component B[f, t] of the harmonic suppressed component D[n, t] obtained by suppressing the fine structure of the harmonic component in the high-order component C_{B} as does the frequency converter 62A according to the first embodiment. The generator 64B generates, as the harmonic estimation mask M_{H}[t], a filter for suppressing (that is, estimating the harmonic component), as a noise component, the frequency component B[f, t] corresponding to the result of estimation of the fine structure of the nonharmonic component against the frequency component A[f, t] for each unit period.

Specifically, the generator 64B computes a Wiener filter represented by Equation (10) as processing coefficients G_{H}[f, t] of the harmonic estimation mask M_{H}[t]. In Equation (10), max( ) refers to an operator for selecting a maximum value in the parentheses and represents an operation for setting the processing coefficients G_{H}[f, t] to a non-negative number.

$${G}_{H} [ f , t ] = max ( \frac{{\vert A [ f , t ] \vert}^{2} - {\vert B [ f , t ] \vert}^{2}}{{\vert A [ f , t ] \vert}^{2}} , 0 ) \qquad ( 10 )$$

The method of generating the harmonic estimation mask M_{H}[t] is not limited to the above-described example. For example, a noise suppression filter generated through a minimum mean-square error short-time spectral amplitude estimator (MMSE-STSA) or an MMSE-long spectral amplitude estimator (MMSE-LSA), or a noise suppression filter based on previous SNR estimated through a decision-direction (DD) method may be employed as the harmonic estimation mask M_{H}[t].

As shown in FIG. 4, the signal processor 40 according to the second embodiment of the invention includes a first processor 72B and a second processor 74B. The first processor 72B generates the frequency component Y_{H}[f, t] of the sound signal S_{H} by applying the harmonic estimation mask M_{H}[t] generated by the separation mask generator 38 (generator 64B) to the frequency component X[f, t] of the sound signal S_{X} (for example, by multiplying the frequency component X[f, t] of the sound signal S_{X} by the harmonic estimation mask M_{H}[t]), in the same manner as the first processor 72A of the first embodiment.

The second processor 74B generates the frequency component Y_{P}[f, t] of the sound signal S_{P} through a noise suppression process for suppressing, as a noise component, the frequency component Y_{H}[f, t] computed by the first processor 72A from among the frequency component X[f, t] of the sound signal S_{X}. Specifically, the second processor 74B generates a filter for suppressing (estimating the nonharmonic component) the frequency component Y_{H}[f, t] as the nonharmonic estimation mask M_{P}[t] from the frequency component X[f, t] and the frequency component Y_{H}[f, t] (e.g. G_{P}[f, t]={|X[f, t]|²−|Y_{H}[f, t]|²}/|X[f, t]|²), and computes the frequency component Y_{P}[f, t] by applying the nonharmonic estimation mask M_{P}[t] to the frequency component X[f, t] in the same manner as the second processor 74A of the first embodiment. A known noise suppression technique such as MMSE-STSA, MMSE-LSA, etc. may be employed to generate the nonharmonic estimation mask M_{P}[t].

The second embodiment achieves the same effect as that of the first embodiment. While the filter for suppressing the frequency component B[f, t] over the frequency component A[f, t] is generated as the harmonic estimation mask M_{H}[t] in the above-described embodiment, a filter for suppressing the frequency component B[f, t] from the frequency component X[f, t] of the sound signal S_{X} may be generated as the harmonic estimation mask M_{H}[t] (e.g. G_{H}[f, t]={|X[f, t]|²−|B[f, t]|²}/|X[f, t]|²)

### Third Embodiment

FIG. 5 is a block diagram of the harmonic suppressor 36, the separation mask generator 38 and the signal processor 40 according to the third embodiment of the present invention. The harmonic suppressor 36 according to the third embodiment includes a component extractor 52C and a suppression processor 54C. The component extractor 52C extracts a low-order component C_{A}[n, t] and the high-order component C_{B}[n, t] from the cepstrum C[n, t] computed by the feature extractor 34. The high-order component C_{B}[n, t] is a component of the high-order region Q_{B} in which quefrency n exceeds the threshold value L, as in the first embodiment, whereas the low-order component C_{A}[n, t] is a component (i.e. component in which the envelope structure of the sound signal S_{X} has been predominantly reflected) of the low-order region Q_{A} in which quefrency n is less than the threshold value L. The suppression processor 54C generates the harmonic suppressed component D[n, t] by suppressing peaks of the high-order component C_{B}[n, t] in the same manner as the suppression processor 54A of the first embodiment.

The separation mask generator 38 according to the third embodiment includes a frequency converter 62C and a generator 64C. The frequency converter 62C transforms the low-order component C_{A}[n, t] (i.e. the low-order region Q_{A} of the cepstrum C[n, t] computed by the feature extractor 34) extracted by the component extractor 52C and the harmonic suppressed component D[n, t] obtained through processing by the harmonic suppressor 36 (suppression processor 54C) into the frequency domain to generate a frequency component (amplitude spectrum) E[f, t]. For example, it is possible to employ a configuration in which a cepstrum corresponding to a combination of the low-order component C_{A}[n, t] and the high-order component C_{B}[n, t] is transformed into an amplitude spectrum and a configuration in which an amplitude spectrum converted from the low-order component C_{A}[n, t] and an amplitude spectrum converted from the high-order component C_{B}[n, t] are combined.

While the frequency component B[f, t] of the first embodiment corresponds to the amplitude spectrum obtained by suppressing the harmonic structure of the harmonic component for the fine structure from which the envelope structure (low-order component C_{A}[n, t]) of the sound signal S_{X} has been eliminated, the frequency component E[f, t] of the third embodiment corresponds to an amplitude spectrum obtained by suppressing the harmonic structure of the harmonic component for the sound signal S_{X} including both the envelope structure and the fine structure (i.e. amplitude spectrum in which the envelope structures of the harmonic and nonharmonic components and the fine structure of the nonharmonic component have been reflected).

The generator 64C of the third embodiment generates a filter for suppressing (i.e. estimating the harmonic component), as a noise component, the frequency component E[f, t] generated by the frequency converter 62C for the frequency component X[f, t] of the sound signal S_{X} as the harmonic estimation mask M_{H}[t] for each unit period. For example, the generator 64C computes a Wiener filter represented by Equation (11) as the processing coefficients G_{H}[f, t] of the harmonic estimation mask M_{H}[t].

$${G}_{H} [ f , t ] = max ( \frac{{\vert X [ f , t ] \vert}^{2} - {\vert E [ f , t ] \vert}^{2}}{{\vert X [ f , t ] \vert}^{2}} , 0 ) \qquad ( 11 )$$

As shown in FIG. 5, the signal processor 40 of the third embodiment includes a first processor 72C and a second processor 74C. The first processor 72C generates the frequency component Y_{H}[f, t] of the sound signal S_{H} by applying the harmonic estimation mask M_{H}[t] generated by the separation mask generator 38 (generator 64C) to the frequency component X[f, t] of the sound signal S_{X} in the same manner as the first processor 72B of the second embodiment. The second processor 74C generates the frequency component Y_{P}[f, t] of the sound signal S_{P} through a noise suppression process for suppressing the frequency component Y_{H}[f, t] computed by the first processor 72C, as a noise component, for the frequency component X[f, t] of the sound signal S_{X} in the same manner as the second processor 74B of the second embodiment.

The third embodiment also achieves the same effect as that of the first embodiment. Since the low-order component C_{A}[n, t] of the cepstrum C[n, t] computed by the feature extractor 34 is used along with the high-order component C_{B}[n, t] to generate the harmonic estimation mask M_{H}[t] in the third embodiment, it is possible to separate the sound signal S_{X} into the harmonic component and the nonharmonic component with high accuracy, compared to the second embodiment in which the low-order component C_{A}[n, t] is not used.

The configuration of the third embodiment, which uses the low-order component C_{A}[n, t] of the cepstrum C[n, t], may be equally applied to the first embodiment of the invention. For example, the separation mask generator 38 calculates the nonharmonic estimation mask M_{P}[t] based on the frequency component E[f, t] and the frequency component X[f, t] (e.g. G_{P}[f, t]=E[f, t]/X[f, t]) and computes the harmonic estimation mask M_{H}[t] according to Equation (7). The signal processor 40 generates the sound signal S_{P} by applying the nonharmonic estimation mask M_{P}[t] to the frequency component X[f, t] and generates the sound signal S_{H} by applying the harmonic estimation mask M_{H}[t] to the frequency component X[f, t].

### Modifications

The above-described embodiments can be modified in various manners. Detailed modifications will be described below. Two or more embodiments arbitrarily selected from the following embodiments can be appropriately combined.

(1) The method of suppressing peaks of the cepstrum C[n, t] in the high-order region Q_{B} is not limited to the above-described example (median filter of Equation (3)). For example, peaks in the high-order region Q_{B} may be suppressed through threshold processing for modifying the cepstrum C[n, t] that exceeds a predetermined threshold value within the high-order region Q_{B} into a value less than the threshold value. However, the configuration in which the median filter of Equation (3) is used has the advantage that the threshold value need not be set (and thus there is no possibility that separation accuracy varies with the threshold value). Furthermore, the cepstrum C[n, t] in the high-order region Q_{B} may be smoothed by calculating the moving average of the cepstrum C[n, t] to suppress peaks of the cepstrum C[n, t]. In addition, peaks of the cepstrum C[n, t] in the high-order region Q_{B} may be detected and suppressed. A known detection technique may be employed to detect peaks in the high-order region Q_{B}. For example, a method of differentiating the cepstrum C[n, t] in the high-order region Q_{B} to analyze variation in the cepstrum C[n, t] with respect to quefrency n is preferably employed.

In the third embodiments, the harmonic suppressor 36 may generate a harmonic suppressed component D′ [n, t] by substituting 0 for the high-order region Q_{B} in the cepstrum C[n, t] computed by the feature extractor 34 and sustaining the component of the low-order region Q_{A}, and the frequency converter 62C may generate the frequency component E[f, t] by transforming the harmonic suppressed component D′[n, t] into the frequency domain. According to this configuration, computation with respect to the high-order region Q_{B} during transformation into the frequency domain by the frequency converter 62C can be omitted, and thus computational load of the frequency converter 62C can be reduced. In addition, the process of substituting 0 for the cepstrum C[n, t] in the high-order region Q_{B} corresponds to elimination of the fine structure (i.e. smoothing of the amplitude spectrum in the direction of the frequency domain). As described in non-patent references 1 and 2, since the nonharmonic component tends to be sustained in the direction of the frequency domain, accuracy of separation of the nonharmonic component from the harmonic component can be improved according to the configuration in which the amplitude spectrum is smoothed by substituting 0 for the cepstrum C[n, t] in the high-order region Q_{B}. According to smoothing of the amplitude spectrum, described above, a configuration in which a predetermined value close to 0 is substituted for the cepstrum C[n, t] in the high-order region Q_{B} may be implemented in addition to the configuration in which 0 is substituted for the cepstrum C[n, t] in the high-order region Q_{B}. A process of substituting 0 or a value close to 0 for the cepstrum C[n, t] may involve a process of approximating the cepstrum C[n, t] to 0.

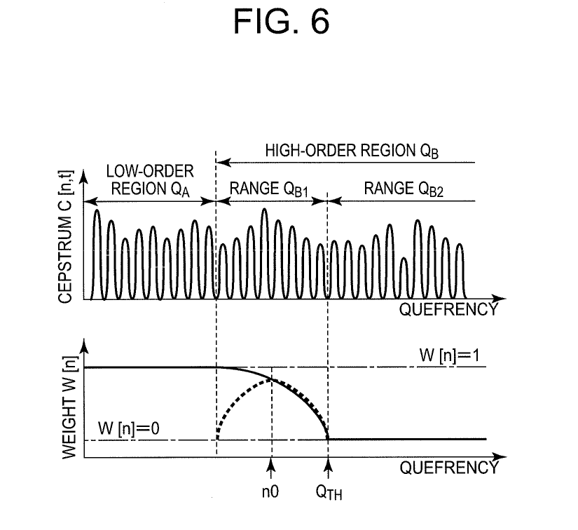

As shown in FIG. 6, it is possible to divide the high-order region Q_{B} into a range Q_{B1} and a range Q_{B2} on the basis of a predetermined threshold value Q_{TH} and to respectively suppress the range Q_{B1} and range Q_{B2} through individual methods. Specifically, the harmonic suppressor 36 generates the harmonic suppressed component D′[n, t] by multiplying the cepstrum C[n, t] in the high-order region Q_{B} by a weight W[n] computed according to Equation (12) and then suppressing peaks in the range Q_{B1}.

$$W [ n ] = \{ \begin{matrix}0.5 - 0.5 cos ( \frac{2 π ( n - {Q}_{TH} )}{2 {Q}_{TH}} ) & ( n \leq {Q}_{TH} ) \\ 0 & ( n > {Q}_{TH} )\end{matrix} \qquad ( 12 )$$

As is known from Equation (12) and FIG. 6 (solid line), in the range Q_{B1} in which quefrency n is less than the threshold value Q_{TH} in the high-order region Q_{B}, the weight W[n] is set such that it is reduced from 1 to 0 for increase of quefrency n. The arithmetic expression of the weight W[n] with respect to the range Q_{B1}, represented as Equation (12), corresponds to the right half of the Hanning window. Peaks of the cepstrum C[n, t] in the range Q_{B1} are suppressed through the same method (Equation (3)) as that of the first embodiment, for example, after being multiplied by the weight W[n]. In the range Q_{B2} in which quefrency n exceeds the threshold value Q_{TH} in the high-order region Q_{B}, the weight W[n] is set to 0 to substitute 0 for the cepstrum C[n, t], suppressing peaks of the cepstrum C[n, t]. The cepstrum C[n, t] in the low-order region Q_{A} is sustained as in the third embodiment.

While the weight W[n] monotonously decreases in response to increase of the quefrency n in the range Q_{B1} in the above description, the variation form of the weight W[n] in the range Q_{B1} may be appropriately modified. For example, it is possible to set the weight W[n] such that the weight [n] can continuously increase in response to increase of the quefrency n over the range from the end point of the low-order side of the range Q_{B1} to a predetermined point n0 (e.g. the center point of the range Q_{B1}) and continuously decrease for increase of the quefrency n over the range from the point n0 to the end point of the high-order side of the range Q_{B1}, as indicated by a dotted line in FIG. 6. The cepstrum C[n, t] is multiplied by the weight W[n] indicated by the dotted line of FIG. 6, and then peaks in the range Q_{B1} are suppressed. In the range Q_{B2}, the cepstrum C[n, t] approximates to 0 (typically, 0 is substituted for the cepstrum C[n, t]) as described above. According to the above-described configuration, it is possible to selectively emphasize a sound component of a fundamental frequency corresponding to a quefrency n near the center (point n0) of the range Q_{B1}. As is understood from the above description, each peak of the cepstrum C[n, t] is suppressed by adjusting the cepstrum C[n, t] using the weight W[n] that continuously varies with increase of quefrency n for the range Q_{B1} in the high-order region Q_{B}, as described with reference to FIG. 6 (solid line and dotted line), and the variation form of the weight W[n] is arbitrary.

(2) Peaks of the cepstrum C[n, t] tend to be concentrated in a specific range corresponding to pitches of the sound signal S_{X} in the overall range of quefrencies n. In view of this, it is possible to suppress peaks of the cepstrum C[n, t] within a range of the high-order region Q_{B}, which corresponds to pitches assumed to be a harmonic component of the sound signal S_{X} (Equation (3)) and to omit suppression of peaks in the remaining range of the high-order region Q_{B}. Furthermore, it is possible to variably control peak suppression range based on pitches estimated from the sound signal S_{X} (for example, a range including estimated pitches is set as a peak suppression range). According to the configuration in which peaks are suppressed for a specific range in the high-order region Q_{B}, processing load of the suppression processor 54 (54A, 54B and 54C) can be reduced compared to the above-described embodiments in which peaks are suppressed for the overall range of the high-order region Q_{B}. In addition, considering that peaks of the cepstrum C[n, t] are concentrated in a range based on pitches of the sound signal S_{X}, a configuration in which the threshold value L corresponding to the boundary of the low-order region Q_{A} and the high-order region Q_{B} is variably controlled according to pitches of the sound signal S_{X} is preferably employed.

(3) The method (method of liftering the cepstrum C[n, t]) of extracting the high-order component C_{B}[n, t] is not limited to the above-described example (Equation (2)). For example, the high-order component C_{B}[n, t] can be computed according to Equation (13).

C_{B}[n,t]=α[n]×C[n,t] (13)

In Equation (13), a coefficient (weight) a acting on the cepstrum C[n, t] is represented by Equation (14).

$$α [ n ] = \{ \begin{matrix}0 & ( n < L - 2 {Q}_{L} ) \\ 0.5 - 0.5 cos ( \frac{2 π ( 0.5 n - {Q}_{L} )}{2 {Q}_{L}} ) & ( L - 2 {Q}_{L} \leq n < L ) \\ 1 & ( n \geq L )\end{matrix} \qquad ( 14 )$$

In Equation (14), the trace of the coefficient α[n] in a range (L−2Q_{L}≦n<L) having a width of 2Q_{L} located at the low order side of the threshold value L is represented as a Hanning window. The variable Q_{L} corresponds to half the size of the Hanning window. As is understood from the above description, the coefficient α[n] is set to 0 in the low-order region Q_{A} (n<L−2Q_{L}) of quefrency n, continuously increases in the range from a predetermined point (n=L−2Q_{L}) to the threshold value L, and is set to 1 in the high-order region Q_{B} (n≧L). In the configuration in which 0 is substituted for the cepstrum C[n, t] of the low-order region Q_{A}, as represented by Equation (2), ripples caused by discrete variation in the cepstrum C[n, t] may be generated. According to operations of Equations (13) and (14), the ripples which become a problem in Equation (2) can be effectively prevented because the coefficient α[n] continuously varies according to quefrency n.

(4) While the configuration in which the sound signal S_{H} and the sound signal S_{P} are selectively reproduced is described in each of the above-described embodiments, processing with respect to the sound signal S_{H} or the sound signal S_{P} is not limited to the above-described example. For example, it is possible to employ a configuration in which individual audio processing is performed on each of the sound signal S_{H} and the sound signal S_{P} and then the processed sound signal S_{H} and sound signal S_{P} are mixed and reproduced. The audio processing for each of the sound signal S_{H} and the sound signal S_{P} includes audio adjustment and application of effects. It is also possible to individually perform audio processing such as pitch shift, time stretch or the like on each of the sound signal S_{H} and the sound signal S_{P}. Furthermore, while both the sound signal S_{H} and the sound signal S_{P} are generated in the above-described embodiments, one of the sound signal S_{H} and the sound signal S_{P} may be generated (generation of the other is omitted) and one of the harmonic estimation mask M_{H}[t] and the nonharmonic estimation mask M_{P}[t] may be generated.

(5) The present invention may be freely used. For example, the present invention is preferably applied to a noise suppression apparatus that removes a nonharmonic noise component from a sound signal S_{X}. Specifically, it is possible to remove nonharmonic noise components (percussive components) such as collision sound, sound generated when a door is opened or closed, sound of HVAC (heating, ventilation, air conditioning) equipment, etc. from a sound signal S_{X} received by a communication system such as a teleconference system or a sound signal S_{X} recorded by a sound recording apparatus (voice recorder). In addition, it is possible to extract a non-harmonic noise component from a sound signal S_{X} in order to observe characteristics of the noise component in an acoustic space.

The present invention may be preferably used to extract or suppress a specific sound component (harmonic component/nonharmonic component) from a sound signal S_{X} including sound of a musical instrument. For example, a percussive tapping sound, such as nonharmonic sound and rhythmical sound of percussion, can be extracted or suppressed. In addition, sounds of harmonic musical instruments such as a string instrument, keyboard instrument, wind instrument, etc. tend to become percussive components in an interval (attack part) immediately after the sounds are generated and to be sustained as harmonic components in an interval (sustain part) after the attack part. The present invention can be preferably used to extract or suppress one of the attack part (nonharmonic component) and the sustain part (harmonic component) of sound of a musical instrument. Furthermore, since distortion of an electric guitar, for example, corresponds to a nonharmonic component, the present invention can be used to extract or suppress the distortion of the electric guitar included in a sound signal S_{X}.

(6) While the sound processing apparatus 100 including both the component (signal processor 40) for separating the sound signal S_{X} into the sound signal S_{H} and the sound signal S_{P} and the component (harmonic suppressor 36 and the separation mask generator 38) for generating the separation masks used to separate the sound signal S_{X} is exemplified in the above-described embodiments, the present invention is specified as a sound processing apparatus (separation mask generation apparatus) for generating a separation mask. For example, the separation mask generation apparatus includes the harmonic suppressor 36 and the separation mask generator 38, acquires the sound signal S_{X} (or frequency component X[f, t] and cepstrum C[n, t] estimated from the sound signal S_{X}) from an external device, generates a separation mask through the same method as each of the above-described embodiments and provides the separation mask to the external device. The separation mask generation apparatus and the external device exchange the sound signal S_{X} and the separation mask through a communication network such as the Internet. The external device separates the sound signal S_{X} into a harmonic component and a nonharmonic component using the separation mask provided by the separation mask generation apparatus. As is understood from the above description, the frequency analyzer 32, the feature extractor 34, the signal processor 40 and the waveform generator 42 are not essential components used to generate a separation mask.

What is claimed is:

1. A sound processing apparatus comprising one or more of processors configured to:
suppress peaks that exist in a high-order region of a cepstrum of a sound signal and that correspond to a harmonic structure of the sound signal; and
generate a separation mask used to suppress a harmonic component or a nonharmonic component of the sound signal based on a resultant cepstrum in which the peaks of the high-order region have been suppressed.

2. The sound processing apparatus of claim 1, wherein the processor is further configured to:
compute the cepstrum of the sound signal; and
apply the separation mask to the sound signal.

3. The sound processing apparatus of claim 2, wherein the processor is configured to:
generate, as the separation mask, a harmonic estimation mask capable of suppressing the nonharmonic component of the sound signal and a nonharmonic estimation mask capable of suppressing the harmonic component of the sound signal; and
apply the harmonic estimation mask to the sound signal and apply the nonharmonic estimation mask to the sound signal.

4. The sound processing apparatus of claim 2, wherein the processor is configured to:
generate, as the separation mask, a harmonic estimation mask capable of suppressing the nonharmonic component of the sound signal;
apply the harmonic estimation mask to the sound signal to estimate the harmonic component of the sound signal; and
estimate the nonharmonic component of the sound signal by suppressing the estimated harmonic component from the sound signal.

5. The sound processing apparatus of claim 1, wherein the processor is configured to:
transform a low-order component of the cepstrum computed from the sound signal and a high-order component of the resultant cepstrum, in which the peaks have been suppressed, into a first spectrum of a frequency domain; and
generate the separation mask based on the first spectrum and a second spectrum of the sound signal.

6. The sound processing apparatus of claim 1, wherein the processor is configured to suppress the peaks existing in the high-order region of the cepstrum corresponding to the harmonic structure of the sound signal by substituting 0 for the high-order region of the cepstrum.

7. The sound processing apparatus of claim 1, wherein the processor is configured to adjust the cepstrum in a first range corresponding to a low-order side of the high-order region of the cepstrum according to a weight continuously varying with increase of quefrency so as to suppress the peaks, and approximate the cepstrum in a second range corresponding to a high-order side with respect to the first range in the high-order region to 0.

8. The sound processing apparatus of claim 1, wherein the processor is configured to suppress only a part of the peaks that belongs to a predetermined range of the high-order region of the cepstrum and that corresponds to a pitch of the sound signal.

9. A sound processing method comprising the steps of:
suppressing peaks that exist in a high-order region of a cepstrum of a sound signal and that correspond to a harmonic structure of the sound signal; and
generating a separation mask used to suppress a harmonic component or a nonharmonic component of the sound signal based on a resultant cepstrum in which the peaks of the high-order region have been suppressed.

10. The sound processing method of claim 9, further comprising the steps of:
computing the cepstrum of the sound signal; and
applying the separation mask to the sound signal.

11. The sound processing method of claim 10, wherein
the step of generating generates, as the separation mask, a harmonic estimation mask capable of suppressing the nonharmonic component of the sound signal and a nonharmonic estimation mask capable of suppressing the harmonic component of the sound signal; and
the step of applying applies the harmonic estimation mask to the sound signal and applies the nonharmonic estimation mask to the sound signal.

12. The sound processing method of claim 10, wherein
the step of generating generates, as the separation mask, a harmonic estimation mask capable of suppressing the nonharmonic component of the sound signal; and
the step of applying applies the harmonic estimation mask to the sound signal to estimate the harmonic component of the sound signal; and
the method further comprises the step of estimating the nonharmonic component of the sound signal by suppressing the estimated harmonic component from the sound signal.

13. The sound processing method of claim 9, further comprising the step of transforming a low-order component of the cepstrum computed from the sound signal and a high-order component of the resultant cepstrum, in which the peaks have been suppressed, into a first spectrum of a frequency domain, wherein the step of generating generates the separation mask based on the first spectrum and a second spectrum of the sound signal.

14. The sound processing method of claim 9, wherein the step of suppressing suppresses the peaks existing in the high-order region of the cepstrum corresponding to the harmonic structure of the sound signal by substituting 0 for the high-order region of the cepstrum.

15. The sound processing method of claim 9, wherein the step of suppressing adjusts the cepstrum in a first range corresponding to a low-order side of the high-order region of the cepstrum according to a weight continuously varying with increase of quefrency so as to suppress the peaks, and approximates the cepstrum in a second range corresponding to a high-order side with respect to the first range in the high-order region to 0.

16. The sound processing method of claim 9, wherein the step of suppressing suppresses only a part of the peaks that belongs to a predetermined range of the high-order region of the cepstrum and that corresponds to a pitch of the sound signal.
